(19) United States
(12) Patent Application Publication
(10) Pub. No.: US 2010/0211629 A1
(43) Pub. Date: Aug. 19, 2010

(54) EXPANDABLE ELEMENT MANAGEMENT SYSTEM IN WIRELESS COMMUNICATION NETWORK

(75) Inventors: Jung-Hyun Ok, Seoul (KR); Se-Whan Ko, Seongnam (KR); Eun-Kyu Kim, Seoul (KR)

Correspondence Address: AMPACC Law Group, 3500 188th Street S.W., Suite 103, Lynnwood, WA, 98037, US

(73) Assignee: POSDATA CO., LTD, Seongnam-si, Kyeonggi-do (KR)

(21) Appl. No.: 12/377,385

(22) PCT Filed: Aug. 16, 2007
(86) PCT No.: PCT/KR07/03923

§ 371 Date: Feb. 12, 2009

(30) Foreign Application Priority Data
Aug. 18, 2006 (KR) 10-2006-0078175

(51) Int. Cl. G06F 15/173; G06F 15/16

(52) U.S. Cl. 709/203; 709/223

(57) ABSTRACT

Disclosed is an expandable EMS that can efficiently manage an RAS and an ACR (i.e. network elements of a wireless communication network) and flexibly expand performance and functions of a system according to an increase in the elements. The expansible EMS of a wireless communication network, the expansible EMS including: an EMS application server for performing at least one of a configuration management function, a fault management function, a download management function, and a status management function for elements, in response to a command transmitted from an EMS client; and at least one EMS element interface server directly connected with the elements, the at least one EMS element interface server receiving a message and data from the elements and providing the received message and data to the EMS application server, wherein the EMS element interface server is separated from the EMS application server.

### TECHNICAL FIELD

The present invention relates to an Element Management System (EMS) of a wireless communication network, and more particularly to an expandable EMS for efficiently managing network elements of a wireless communication network, such as an ACR and an RAS. Further, the present invention relates to an EMS capable of flexible expansion by adding an EMS element interface server according to an increase in elements.

### BACKGROUND ART

With the recent development of electronic/communication technology, a variety of communication services have been provided using a wireless communication network, such as mobile communication, a portable internet, etc. As shown in FIG. 1, a wireless communication network includes network elements such as a Portable Subscriber Station (PSS), a Radio Access station (RAS), and an Access Control Router (ACR). Herein, the PSS communicates with the RAS through a wireless communication channel, so that the PSS can use a variety of communication services provided from the ACR interworking with the RAS.

The detailed function of these elements will be described taking an example of a case where a wireless communication network provides a portable internet service. A PSS performs various functions including a portable internet wireless connection function, an IP based service connection function, an IP mobility function, a terminal/user authentication and security function, a multicast service reception function, an interworking function with another network, etc. Herein, the RAS performs various functions including a portable internet wireless connection function, a wireless resource management and control function, a mobility (handoff) support function, an authentication and security function, a Quality of Service (QoS) management function, a downlink multicast function, a billing and statistics generation function, a reporting function, etc. Herein, the ACR performs various functions including an IP routing and mobility management function, an authentication and security function, a QoS management function, a billing service provision function, a mobility control function between RASs within ACRs, a resource management and control function, etc.

Meanwhile, it is necessary to manage network elements, such as an ACR and an RAS in order to stably provide a portable internet service. For example, the portable internet service requires an element management system which can effectively perform various functions including managements of configuration, fault, download, diagnostics & test, statistics, performance, etc.

Particularly, there has been a request for easily expandable EMS, which can flexibly manage network elements increasing in proportion to the number of portable interne subscribers or the number of equipment.

### DISCLOSURE OF INVENTION

### Technical Problem

Therefore, the present invention has been made in view of the above-mentioned problems, and the present invention provides an Element Management System (EMS) of a wireless communication network effectively managing network elements, such as an RAS and an ACR so as to provide a wireless communication service.

In addition, the present invention provides an expansible EMS which can implement an EMS application server and an EMS element interface server separately, thereby achieving easy expansion of performance or functions for a system through simple addition of an EMS element interface server according to a future network element increase.

Further, the present invention provides an EMS, which includes a Network Management System (NMS) interface unit separately constructed within an EMS application server, so that it is possible to easily apply an EMS application server to an environment where there is no NMS.

### Technical Solution

In accordance with an aspect of the present invention, there is provided an expansible EMS of a wireless communication network, the expansible EMS including: an EMS application server for performing at least one of a configuration management function, a fault management function, a download management function, and a status management function for elements, in response to a command transmitted from an EMS client; and at least one EMS element interface server directly connected with the elements, the at least one EMS element interface server receiving a message and data from the elements and providing the received message and data to the EMS application server, wherein the EMS element interface server is separated from the EMS application server.

In accordance with another aspect of the present invention, there is provided an expansible EMS of a wireless communication network, the expansible EMS including: an EMS application server comprising a system back-end function unit for performing at least one of a configuration management function, a fault management function, a download management function, and a status management function, in response to a command transmitted from an EMS client, and a system resource management unit for transmitting the command to an EMS element interface server; and at least one EMS element interface server comprising an interface for matching with the elements based on TCP communication or SNMP communication, and a system resource agent for managing the interface by interworking with the system resource management unit.

### ADVANTAGEOUS EFFECTS

According to the present invention, it is possible to efficiently manage an RAS and an ACR so as to provide a stable wireless communication service, by implementing an element management system for managing network elements of a wireless communication network.

Further, according to the present invention, an EMS application server and an EMS element interface server are separated from each other, so that it is possible to expand performance and functions of a system by adding only an EMS element interface server when future network elements increase due to the increase in equipment or subscribers of the portable internet. Therefore, the present invention enables easy expansion of performance or functions of a system even without addition of an entire EMS system.

### BRIEF DESCRIPTION OF THE DRAWINGS

The foregoing and other objects, features and advantages of the present invention will become more apparent from the following detailed description when taken in conjunction with the accompanying drawings in which:

FIG. 1 shows an example of a hierarchical structure of a wireless communication network;

FIG. 2 shows a block diagram of an expandable EMS according to the present invention;

FIG. 3 shows a detailed block diagram of an EMS application server shown in FIG. 2; and

FIG. 4 shows a block diagram of an EMS client according to the present invention.

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

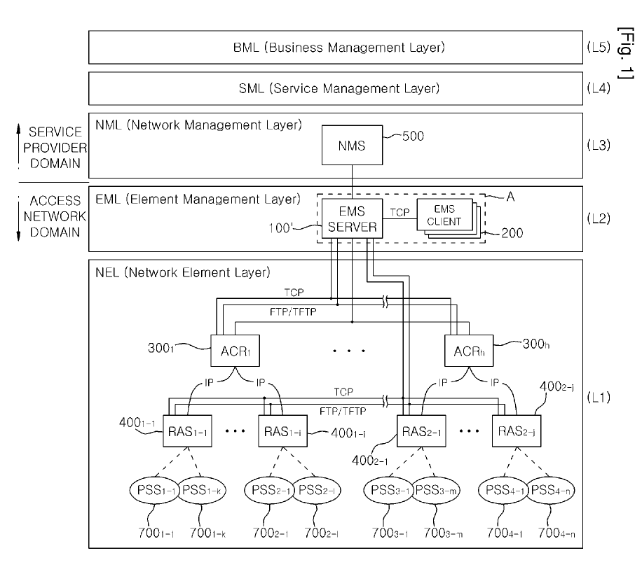

Hereinafter, the hierarchical structure of the wireless communication network according to the present invention will be described with reference to FIG. 1. The wireless communication network may be classified into an access network domain for operation environment setting of network elements, wired/wireless resource management, status checking, etc., and a service provider domain for mobile communication/portable internet service provision, subscriber management, etc. Herein, the access network domain includes a Network Element Layer (NEL) (L1) and an Element Management Layer (EML) (L2), and the service provider domain includes a Network Management Layer (NML) (L3), a Service Management Layer (SML) (L4), and a Business Management Layer (BML) (L5).

At the NEL (L1), network elements, such as a PSS 700, an RAS 400, an ACR 300, etc., are placed. At the EML (L2), an Element Management System (EMS) server 100′ and an EMS client 200 managing the PSS, the RAS, the ACR, etc., are placed.

Meanwhile, the EMS server 100′ is connected with a Network Management System (NMS) 500 placed at the NML (L3), and the EMS server 100′ enables a service provider to manage network elements through the NMS.

According to one feature of the present invention, the EMS is constructed to be applicable to an environment having no network management layer (L3), which will be described later in more detail.

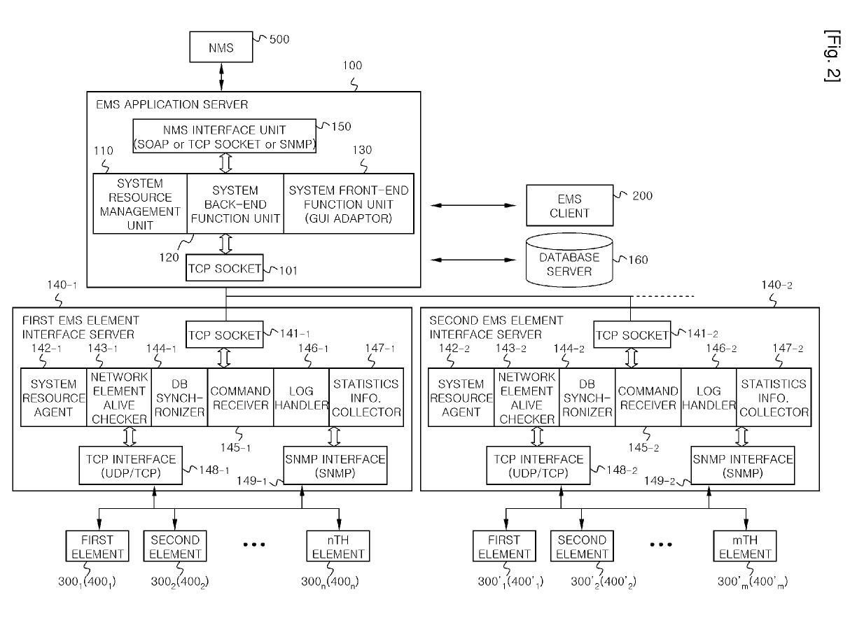

FIG. 2 shows a block diagram of an expansible EMS according to a preferred embodiment of the present invention.

As shown in FIG. 2, the expansible EMS according to the present invention includes an EMS application server 100 and one or more EMS element interface servers 140₋₁ and 140₋₂. Herein, the EMS application server is mutually connected with the EMS element interface server through a TCP socket.

Each of the EMS element interface servers 140 and 140 is directly connected with network elements by a wire/wired line. Each of the EMS element interface servers 140₋₁ and 140₋₂ performs a matching function such as transmission of a command to the elements and reception of data and a message provided by the elements. The EMS application server 100 manages the EMS element interface server and performs a corresponding function based on a command transmitted from an EMS client.

The present invention provides an expansible EMS which can implement an EMS application server and an EMS element interface server separately, thereby increasing the capacity of all system by adding only an EMS element interface server even when network elements are increased beyond the system capacity. Therefore, the present invention achieves easy expansion of performance and functions for the system.

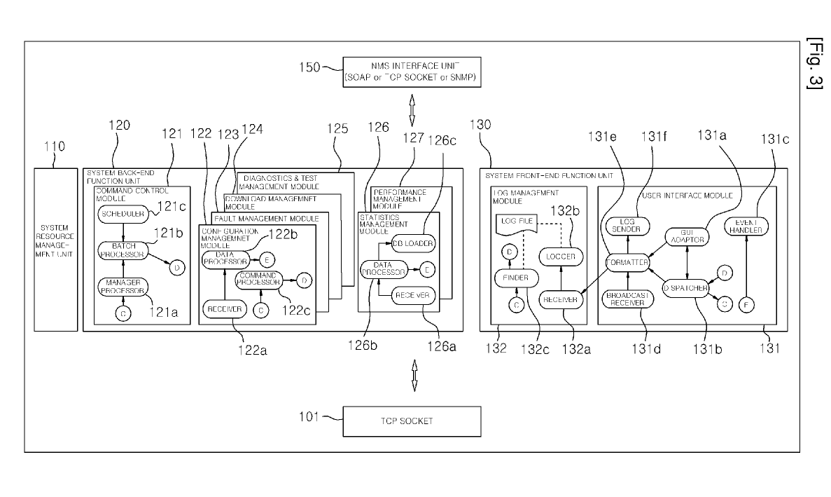

Hereinafter, the EMS application server will be described with reference to FIG. 3.

As shown in FIG. 3, the EMS application server 100 includes a system resource management unit 110, a system back-end function unit 120, a system front-end function unit 130, an NMS interface unit 150, etc.

The system resource management unit 110 interworks with the system back-end function unit 120, the system front-end function unit 130, and the NMS interface unit 150, and the system resource management unit performs various functions including system initialization, system resource management, system maintenance/repair, etc. Specifically, the system resource management unit 110 gathers and monitors data about a CPU load rate, a memory usage rate, a file system usage rate, a network utilization rate for an EMS application server, etc, according to a period or the need of an operator, and generally manages the EMS application server. Moreover, the system resource management unit 110 manages the database server 160 by gathering a database usage status employed in the EMS application server, and performs functions associated with all application processes of the EMS application server, which include state monitoring, operation interruption, and re-operation. Further, the system resource management unit 110 transmits alarm generation information to the EMS client either if a processor unexpectedly goes down or if various usage rates exceed a preset threshold. In contrast, if such usage rates go down below the preset threshold, the system resource management unit 110 transmits alarm release information to the EMS client. In this way, the system resource management unit 110 reports the status information to the operator.

Moreover, in an environment where there is no NMS, the system resource management unit 110 performs functions, including system initialization, system resource management, and system maintenance/repair, without interworking with the NMS interface unit 150.

Meanwhile, the system resource management unit 110 is employed by interworking with each of the system resource agents 142₋₁ and 142₋₂ within each of the EMS element interface servers 140₋₁ and 140₂ so as to manage each of the EMS element interface servers arranged in aseparated manner. Therefore, the EMS application server and each EMS element interface server operate as actually a single EMS server in managing the network elements.

The system front-end function unit 130 includes a user interface module 131 for matching with an operator and a log management module 132 for managing a log.

A user interface module 131 receives an operator command from the EMS client 200 and transmits the received command either to the system back-end function unit 120 or to an EMS element interface server 140. The user interface module receives a response to the command and transmits the received response to a corresponding EMS client. Further, the user interface module receives an event transmitted in real-time from the network element through the EMS element interface server and transmits the received event to the EMS client. To this end, a user interface module includes a GUI adaptor 131a, a dispatcher 131b, an event handler 131c, a broadcast receiver 131d, a formatter 131e, and a log sender 131f.

The GUI adaptor 131a is directly connected with the EMS client (not shown in FIG. 3). When a new EMS client accesses an EMS server over the TCP, the GUI adaptor 131a checks if the new EMS client has an accessible IP address, if the new EMS client is within the range of accessible IP addresses, or if the new EMS client is beyond the number of allowable concurrent users, and then allows the new EMS client to access the EMS application server. The GUI adaptor 131a removes session information regarding a corresponding EMS client when the EMS client is normally or abnormally terminated. Moreover, the GUI adaptor 131a transmits an operator command, transmitted from the EMS client, to the dispatcher and transmits the command to a formatter so as to output a log or a screen of an input format formulated when necessary. Meanwhile, the GUI adaptor 131a receives the response to the operator command from the network element through the dispatcher and transmits the response to the EMS client.

The dispatcher 131b, which is connected with the GUI adaptor, classifies commands received from the EMS client through the GUI adaptor and transmits the classified command either to the system back-end function unit 120 or to the EMS element interface server. The dispatcher 131b receives a response to the operator command and transmits the response to the EMS client through the GUI adaptor. Specifically, when a command received from the EMS client corresponds to a simple processing command related to one element, the dispatcher transmits the command to a command receiver of the EMS element interface server 140. When the command relates to a number of elements such as adjacent cell registration or when the command corresponds to a complex processing command such as a batch command execution to be processed by reading various commands pre-registered in a database, the dispatcher transmits the command to a command control module of the system back-end function unit 120. For reference, the simple processing command used in the present invention refers to a command requiring no operation of the system back-end function unit (e.g. monitoring/modification commands of the element status, monitoring/modification commands of the element parameter, other monitoring commands, etc). Such a simple processing command is directly transmitted from a user interface module to an EMS element interface server, so that it is possible to reduce a load on a server. In contrast, such a complex processing command refers to a command requiring an operation of one or more function modules of the system back-end function unit so as to execute an operator command.

The event handler 131c receives an event, which is generated in a system, from the data processor of a fault management module within the system back-end function unit, and transmits the received event to the EMS client. The event handler 131c also receives a QoS alarm message, generated when a performance threshold set by an operator is exceeded, from a statistics management module and a performance management module, and the event handler transmits the received message to the EMS client. Meanwhile, the broadcast receiver 131d receives a message from the EMS element interface server and transmits the message to the formatter. Then, the formatter 131e receives a message from the broadcast receiver or from the dispatcher and transforms the format of the received message (input/output message formatting formalized by a CLI command), and the formatter transmits the formatted message to a log sender 131f for the output of an operator screen and to a receiver of a log management module for the storage of a log file.

The log management module 132 receives various messages transmitted through the EMS element interface server, and the log management module stores and manages the received messages as a log file. To this end, the log management module includes a receiver 132a, a logger 132b, and a finder 132c. The receiver 132a receives the message from the formatter 131e of the user interface module and transmits the received message to the logger. Then, the logger 132b generates, stores, and manages the log file based on the received message. Meanwhile, in a case where information stored in the log file is needed, the finder 132c retrieves the log file.

The system back-end function unit 120 performs detailed functions or operations of the EMS application server that manages the network elements. In addition, the system back-end function unit 120 includes a command control module, a configuration management module, a fault management module, a download management module, a diagnostics & test management module, a statistics management module, a performance management module, etc.

First, the command control module 121 reads a batch processing command that the EMS client registers in advance, from the database server 160, and transmits the command to network elements through a corresponding EMS element interface server. Then, the command control module 121 receives a response to the command and provides the response to the EMS client. To this end, the command control module includes a manager processor 121a, a batch processor 121b, and a scheduler 121c. Upon receiving a request for a batch job of an operator from the dispatcher of the user interface module, the manager processor 121a transmits the request to the batch processor. Then, the manager processor transmits an individual command corresponding to the batch job from the batch processor to the dispatcher, receives a response to the command, generated by a corresponding network element, from the dispatcher, and transmits the response to the batch processor so that it can be stored in the database server. Also, the manager processor transmits a batch execution termination response to the user interface module when the final command execution is terminated. According to the request for the batch job transmitted either from the manager processor or from the scheduler, the batch processor 121b gets a command pre-registered in the database server in turn, and transmits the command to corresponding network elements, thereby performing the job. Meanwhile, the scheduler reads the batch job stored in the database server and transmits the batch job to the batch processor at predetermined time. Then, the batch processor transmits a command related to the job to corresponding network elements through the EMS element interface server.

The configuration management module 122 performs various functions including physical topology management, operation parameter setting, setting of adjacent cell/adjacent RAS/adjacent ACR of the network element (e.g. RAS, ACR, etc). Specifically, in relation for the element related request message received from the EMS client, the configuration management module receives a result from processing of the element related request message by a corresponding RAS or ACR in the form of an event message through the EMS element interface server. The configuration management module transforms the received result into data that can be stored in the database server, and stores the transformed data in the database server. In a case where an equipment status or an administration state of the network elements is modified, the configuration management module transmits a status modification message to the EMS client through the user interface module. Herein, the physical topology management includes increased/decreased installation of ACR/RAS, increased/decreased installation of frequency assignment/sector/card, etc. Herein, the operation parameter setting includes parameters of a system timer, an OFDMA Physical Layer (PHY) and a Medium Access Control (MAC) layer for uplink/downlink channel, security related Primary Key Management (PKM), a service class for Quality of Service (QoS), a several Radio Frequency (RF), an IP pool, a Dynamic Host Configuration Protocol (DHCP), and an overload threshold, etc.

The fault management module receives fault information transmitted in real-time from the RAS and the ACR (i.e. network elements) and generates viewable and audible information. Specifically, when the fault management module receives a fault occurrence message or a fault release message corresponding to the types of faults (e.g. a specific part of hardware or a specific function of software) from the RAS and the ACR through the EMS element interface server, the fault management module stores the message in the database server and performs an alarm function by broadcasting the fault occurrence message or the fault release message to the EMS client through the user interface module.

The download management module downloads software (OS & application) and a configuration file, used in the RAS and the ACR, (i.e. network elements) into a corresponding network element and performs a function of backing up the configuration file executed in the network element. Specifically, by the operator requirement, at the time of system initialization, or through reservation job registration, the download management module downloads a configuration file and software used according to each network element into a corresponding element, and stores the history information thereof in the database server. The software and the configuration file may be registered in a package management module of the EMS client. Also, through the operator requirement or reservation job registration, the download management module backs up software, which is currently being executed in a corresponding network element, or a configuration file, which is stored in the network element, into the EMS server, and then stores history information thereof in the database server.

The diagnostics & test management module performs a function which tests system resources of the RAS and the ACR (i.e. network elements) and determines existence or absence of faults. Specifically, through reservation test setting of an operator, the diagn ostics & test management module tests resources of the RAS and the ACR at corresponding time, and the diagnostics & test management module reports resource status to an operator through the user interface module upon detecting an insecurity resource. Moreover, in a case where there is a new device or a replaced device, function test of a corresponding device is performed before service provision. In a case where elements have already operated, a service for the resources is interrupted before the start of the diagnosis of a corresponding system.

Meanwhile, each of the configuration management module, the fault management module, the download management module, and the diagnostics & test management module as described above includes a receiver, a data processor, and a command processor (see FIG. 3). The receiver within each of the function modules receives related data from the EMS element interface server, and transmits the received data to the data processor. Then, the data processor processes the data transmitted from the receiver so as to conform to a function of a corresponding module, and stores resultant data in the database server. Also, the command processor within each of the function modules processes a command transmitted from the dispatcher of the user interface module, and performs functions of configuration management, fault management, download management, diagnostics & test management, etc.

The statistics management module performs a function that gathers statistics related data for services and faults of network elements, such as the RAS and the ACR, according to a period (e.g. 60 minutes), and generates statistics data based on a predetermined period (e.g. every day, every week, every month, etc). Specifically, the statistics management module receives performance data and fault data from the RAS and the ACR through the EMS element interface server, generates performance statistics data (e.g. handover statistics, call processing and traffic statistics, radio channel quality statistics, equipment processor load statistics, etc) and fault statistics data according to a predetermined period, and stores the generated data in the database server. When the statistics data exceeds a performance threshold, the statistics management module generates a QoS alarm and transmits the generated QoS alarm to an event handler of a user interface module.

The performance management module gathers and monitors performance related data about the RAS and the ACR, i.e. network elements by periods (e.g. five minutes). Specifically, the performance management module receives a five-minute statistics file containing performance related data from the RAS and the ACR through the EMS element interface server, extracts monitoring item data from the received file, and applies a preset threshold to the file, thereby generating performance monitoring data. Moreover, the performance management module stores and manages the performance monitoring data in the database server. When the performance monitoring data exceeds the threshold, the performance management module generates a QoS alarm message so as to store its history, and transmits the message to the EMS client through a user interface module. The performance related data may include a processor CPU load rate of the RAS and the ACR, a traffic transmission rate/an error rate, the number of connected PSSs, handover failure rate, etc.

Meanwhile, each of the statistics management module and the performance management module as described above includes a receiver, a data processor, and a DB loader (see FIG. 3). A receiver of each function modules receives related data from the EMS element interface server and transmits the received data to the data processor. Each data processor processes the data so as to conform to a function of a corresponding module and transmits the processed data to the DB loader. The DB loader stores the data processed by the data processor in the database server.

The NMS interface unit 150 matches with the NMS, which is an upper system of the EMS server. To this end, the NMS interface unit includes an EMS agent and the NMS manages an EMS server through an EMS manager connected with the EMS agent. It is preferred that communication is performed between the EMS manager and the EMS agent according to the Simple Object Access Protocol (SOAP). Also, the NMS interface unit may include an Operation Support System (OSS) interface for interworking with an OSS of a service provider. The OSS interface is constructed to be separable from the NMS interface. In a case of actually implementing the OSS interface, the OSS interface can be selectively employed according to whether or not a service provider has the OSS.

Further, the NMS interface unit 150 is constructed to be separable from the system resource management unit 110. In an environment where there is no NMS, only the NMS interface unit is separately constructed to be applicable to an environment where there is no NMS.

In a present embodiment, a database is implemented as a separate database server 160 without including a database within the EMS application server. Herein, the database server interworks with servers, such as the EMS application server, and the EMS element interface server and performs a function of storing information regarding each of elements (ACR, RAS, etc) managed by the EMS, which includes package information, configuration information, fault information, statistic information, history information, etc. Of course, it is possible to include the database constructed within the EMS application server.

Referring again to FIG. 2, the EMS element interface server will be described later in more detail. For reference, FIG. 2 shows a first EMS element interface server 140₋₁ and a second EMS element interface server 140₋₂. Herein, the EMS element interface servers are addable and separable according to the number of network elements. Since each of the EMS element interface servers actually has an identical construction, one EMS element interface server 140₋₁ will be mainly described later.

As shown in FIG. 2, the EMS element interface server 140₋₁ includes a TCP socket 141₋₁, a system resource agent 142₋₁, a network element alive checker 143₋₁, a database synchronizer 144₋₁, a command receiver 145₋₁, a log handler 146₋₁, a statistics information collector 147₋₁, a TCP interface 148₋₁, an SNMP interface 149₋₁, etc.

First, the TCP socket 141₋₁ is connected with the TCP socket 101 of the EMS application server for TCP communication. Specially, the TCP socket 141₋₁ intermediates to perform communication between the system resource management unit 110 of the EMS application server and the system resource agent 142₋₁ of the EMS element interface server.

The system resource agent 142₋₁ communicates with the system resource management unit 110 of the EMS application server through the TCP socket 141₋₁ and enables the system resource management unit 110 to actually control the EMS element interface server 140. Therefore, the EMS application server 100 can manage the network element alive checker 143₋₁, the database synchronizer 144₋₁, the command receiver 145₋₁, the log handler 146₋₁, and the statistics information collector 147₋₁, which are included in the EMS element interface server, through the system resource agent 142₋₁.

The network element alive checker 143₋₁ periodically monitors if the RAS or the ACR (i.e. network element) is alive, and detects link status of TCP or SNMP message communication with elements and the network element alive checker notifies the result massage to the system back-end function unit (fault management module) of the EMS application server. Specifically, the network element alive checker periodically checks element status by using predetermined keep alive message communication regarding the RAS and the ACR managed by the EMS server. As a result of checking element status, when communication is impossible or communication is restarted, the network element alive checker transmits either a fault occurrence message or a fault release message to the fault management module.

The command receiver 145 receives an operator command from the system front-end function unit (user interface module) of the EMS application server and transmits the command to a corresponding network element. Specifically, when receiving the command from the EMS client, the dispatcher of the user interface module classifies the received command and transmits the classified command either to the command control module of the system back-end function unit or to the command receiver of the EMS element interface server. As described above, in a case of a complex processing command requiring operation of the system back-end function unit, the dispatcher of the user interface module transmits the complex processing command to the command control module. In a case of a simple processing command requiring no operation of the system back-end function unit, the dispatcher of the user interface module directly transmits the simple processing command to the command receiver. Then, the command receiver transmits the command to a network element through a proper interface of the TCP interface or the SNMP interface, and the command receiver receives a response to the command and transmits the response to the user interface module of the EMS application server. Meanwhile, when an existing communication interface (e.g. TCP interface, SNMP interface) has an error, the command receiver changes the existing communication interface into another interface capable of communication with a network element, and transmits a command through the new interface.

The database synchronizer 144 performs a function of synchronizing with data stored in the database. In the embodiment shown in FIG. 2, the database is implemented as a separate database server 160. In this case, the EMS element interface server 140₋₁ can perform data synchronization by directly accessing the database server 160 without passing through the EMS application server 100.

The log handler 146₋₁ performs a function of processing a log file regarding the network elements with which the EMS element interface server matches.

The statistics information collector 147₋₁ collects statistics related information regarding the network elements with which the EMS element interface server matches and transmits the collected information to the EMS application server.

The network element alive checker 143₋₁, a database synchronizer 144₋₁ a command receiver 145₋₁, a log handler 146₋₁, a statistics information collector 147₋₁, etc., are included within the EMS element interface server in a separated manner, so that they perform their intrinsic functions for the network elements managed by one EMS element interface server.

The TCP interface 148₋₁ uses TCP so as communicate with the network elements, such as the ACR, and the RAS. The EMS element interface server 140 transmits and receives request/response messages for operation, management, maintenance/repair, etc., regarding the network elements through the TCP interface and the EMS element interface server receives fault information and status information. In the present invention, TCP-based Inter Processor Communication (IPC) is performed in order to achieve rapid message transmission or in order to prevent loss of a message.

The SNMP interface 149 uses SNMP so as to communicate with network elements, such as the RAS and the ACR. To this end, the EMS element interface server 140₋₁ includes an SNMP manager and a corresponding network element includes an SNMP agent. The SNMP manager transmits ‘Get/Get Next/Get Bulk/Set’ commands to the SNMP agent of the network element, receives a response to the commands, and gathers status and setting information of the element, and receives an event and alarm information from the SNMP agent of the element through ‘Trap’. Also, the SNMP manager gathers and synchronizes a Management Information Base (MIB) of the SNMP agent at the request of the MIB synchronization module (not shown).

For reference, FIG. 2 shows the EMS element interface server including both the TCP interface and the SNMP interface. However, one EMS element interface server can be implemented to have only one of the TCP interface and the SNMP interface. For example, in FIG. 2, the first EMS element interface server 140₋₁ may be implemented to have only the TCP interface 148₋₁ for the management of the network elements using TCP communication. The second EMS element interface server 140₋₂ may be implemented to have only the SNMP interface 149₋₂ for the management of the network elements using SNMP communication.

Meanwhile, the EMS element interface server may also include an FTP/TFTP interface (not shown). The FTP/TFTP interface uses FTP/TFTP so as to communicate with the network elements, such as the RAS and the ACR. The EMS element interface server may use an FTP/TFTP interface for file transfer with large amount of data, such as software file transfer, configuration information file transfer, and statistics data file transfer. It is preferred that FTP/TFPT interface is implemented as a separate sub server interworking with the EMS element interface server for smooth operation. For reference, the FTP/TFTP server is not shown in FIG. 2.

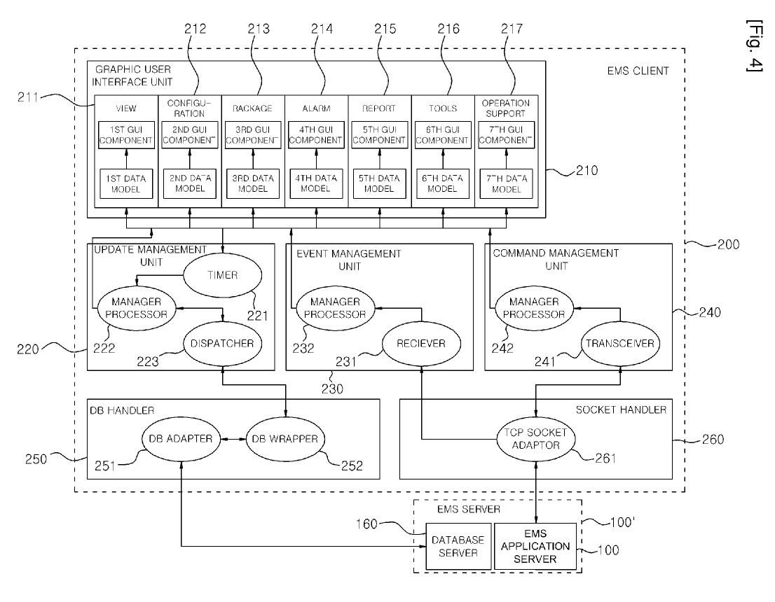

FIG. 4 shows an EMS client according to a preferred embodiment of the present invention.

As shown in FIG. 4, the EMS client 200 includes a graphic user interface unit 210, an update management unit 220, an event management unit 230, a command management unit 240, a DB handler 250, and a socket handler 260, and the EMS client enables operator to synthetically monitor and control the ACR 300 and the RAS 400 through the EMS application server.

First, the graphic user interface unit 210 performs a function for matching with a user or an operator. The graphic user interface unit includes a data model for managing corresponding data and a GUI component according to each item. Herein, the GUI component performs a function for rendering the data model suitable for a corresponding screen for displaying. Herein, the data model performs a function for storing data of equipment and a system, the data containing configuration information, status information, and history information. As an external function, the graphic user interface unit provides a graphic user interface using the GUI component. As an internal function, the graphic user interface unit implements an interface with the update management unit, the event management unit, and the command management unit using the data model. For reference, FIG. 4 shows the graphic user interface for view 211, configuration 212, package 213, alarm 214, report 215, tools 216, operation support 217, etc.

The update management unit 220 monitors network elements and the update management unit periodically gathers and applies detailed history and status of equipment. To this end, the update management unit includes a timer 221, a manager processor 222, a dispatcher 223, etc. It is preferred that the update management unit is implemented to mainly update only related data model and a GUI activated as a current window, so as to optimize the performance thereof. The data of the updated data model is applied to a corresponding GUI component by event processing.

The event management unit 230 receives fault information and status modification information of the network element in real-time through the EMS server, and the event management unit generates or releases an alarm at the time of the fault occurrence event or the fault release event, thereby generating or releasing viewable and audible alarm. To this end, the event management unit includes a receiver 231 and a manager processor 232. The receiver 231 receives an event, transmitted from the EMS server, through the socket handler 260, and transmits the event to the manager processor 232. Then, the manager processor 232 processes the transmitted event and transmits the processed event to the graphic user interface unit 210.

The command management unit 240 processes an operator command using a queue, and transmits the processed command to the socket handler. Then, the command management unit receives an execution response to the command from the socket handler, and transmits the execution response to the graphic user interface unit. To this end, the command management unit 240 includes a transceiver 241 and a manager processor 242. The manager processor 242 receives an operator command from the graphic user interface unit and processed the received command using the queue, and the manager processor reads an individual command from command queue and transmits the command to the transceiver. The transceiver transmits an operator command to the EMS server through the socket handler and transmits the received response to the command to the manager processor.

The DB handler 250 reads data, such as information, status, and history of network elements, and transmits the data to the update management unit. To this end, the DB handler includes a DB adaptor 251 and a DB wrapper 252. Herein, the DB adaptor 251 acquires information regarding a network element from the database server 160, and adds, removes, or modifies data for the database server 160. The DB wrapper 252 performs a function for wrapping the data acquired from the database server according to each management unit.

The socket handler 260 transmits an operator command to the EMS application server 100, receives an alarm event and a command processing response, and transmits the received data to a corresponding management unit. In the present invention, the TCP is used to communicate with the EMS application server 100. FIG. 2 shows a structure connected with the EMS application server through the TCP socket adaptor 261.

In the present invention as described above, an EMS application server and an EMS element interface server are implemented separately, so that it is possible to flexibly add and remove an EMS element interface server according to the number of the network elements (i.e. a management target). For example, it is preferred that the number of EMS element interface servers to be expanded is determined after necessary CPU, a memory, and a hard disk are calculated based on the requirement performance calculation table.

Although not shown in the drawings, it is possible to implement each function module as a separate server within a system back-end function unit of an EMS application server. In this case, it is also possible to implement one or several function modules as a separate server according to the number of network elements (i.e. a management target) or according to the throughput to be processed by the function modules.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An expansible Element Management System (EMS) of a wireless communication network, the expansible EMS comprising:
an EMS application server for performing at least one of a configuration management function, a fault management function, a download management function, and a status management function for elements, in response to a command transmitted from an EMS client; and
at least one EMS element interface server directly connected with the elements, the at least one EMS element interface server receiving a message and data from the elements and providing the received message and data to the EMS application server,
wherein the EMS element interface server is separated from the EMS application server.

2. The expansible EMS as claimed in claim 1, wherein the EMS application server comprises:
a system front-end function unit for matching with the EMS client;
a system back-end function unit for processing the command transmitted from the system front-end function unit and performing at least one function related to the elements of the wireless communication network, which includes a configuration management function, a fault management function, a download management function, and a status management function; and
a system resource management unit for managing the system front-end function unit and the system back-end function unit, and transmitting the command to the EMS element interface server.

3. The expansible EMS as claimed in claim 2, wherein the system front-end function unit comprises a log management module for receiving a message transmitted through the element interface unit, storing the received message as a log file, and managing the log file.

4. The expansible EMS as claimed in claim 2, wherein the system front-end function unit comprises a user interface module for classifying commands transmitted from the EMS client and transmitting the classified commands either to the system back-end function unit or to the EMS element interface server.

5. The expansible EMS as claimed in claim 4, wherein the user interface module comprises a dispatcher for transmitting a command to the EMS element interface server when the command transmitted from the EMS client corresponds to a simple processing command, and transmitting a command to the system back-end function unit when the command corresponds to a complex processing command.

6. The expansible EMS as claimed in claim 5, wherein the system back-end function unit comprises a command control module for receiving and processing the complex processing command from the user interface module.

7. The expansible EMS as claimed in claim 2, wherein the system back-end function unit comprises at least one of:
a configuration management module for performing a configuration management function of the elements;
a fault management module for performing a fault management function of the elements;
a download management module for performing a download management function of the elements;
a diagnostics & test management module for performing a diagnostics & test management function of the elements;
a statistics management module for performing a statistics management function of the elements; and
a performance management module for performing a performance management function of the elements.

8. The expansible EMS as claimed in claim 7, wherein at least one of modules of the system back-end function unit is embodied as a separate sub server.

9. The expansible EMS as claimed in claim 7, wherein at least one of modules of the system back-end function unit performs a message queue communication using a shadow memory.

10. The expansible EMS as claimed in claim 7, wherein the download management module manages software and a configuration file for the elements and downloads the software and the configuration file into the elements.

11. The expansible EMS as claimed in claim 1, wherein the EMS element interface server comprises:
a command receiver for receiving a command transmitted from the EMS application server and transmitting the received command to the elements of the wireless communication network;
an interface for matching with the elements by using TCP communication or SNMP communication; and
a system resource agent for managing the command receiver and the interface by interworking with the system resource management unit.

12. The expansible EMS as claimed in claim 11, wherein the EMS element interface server further comprises at least one of:
a network element alive checker for checking if the elements of the wireless communication network are alive;
a database synchronizer for synchronizing with a database server interworking with the EMS element interface server;
a log handler for processing a log file regarding the elements of the wireless communication network with which the EMS element interface server matches; and
a statistics information collector for collecting statistics related data regarding the elements of the wireless communication network with which the EMS element interface server communicates and transmitting the collected data to the EMS application server.

13. The expansible EMS as claimed in claim 11, wherein the interface comprises at least one of a TCP interface for supporting TCP communication, an SNMP interface for supporting SNMP communication, and an FTP/TFTP interface for supporting FTP/TFTP communication.

14. The expansible EMS as claimed in claim 13, wherein the elements of the wireless communication network comprise an ACR and an RAS, and the EMS element interface server is directly connected with the ACR and the RAS.

15. The expansible EMS as claimed in claim 11, wherein the command receiver supports at least one of the TCP communication, the SNMP communication, and the FTP/TFTP communication.

16. The expansible EMS as claimed in claim 1, wherein the EMS application server and the EMS element interface server perform TCP communication using the TCP socket.

17. The expansible EMS as claimed in claim 1, further comprising a database server for receiving at least one of operation information, configuration information, fault information, and statistic information for the elements from the EMS element interface server, and storing the received information.

18. The expansible EMS as claimed in claim 1, wherein the EMS application server further comprises an Network Management System (NMS) interface unit for matching with the NMS of the wireless communication network, and the NMS interface unit is constructed to be separable from the EMS application server.

19. The expansible EMS as claimed in claim 18, wherein the NMS interface unit comprises an Operation Support System (OSS) interface for interworking with the OSS, and the OSS interface is constructed to be separable from the NMS interface unit.

20. An expansible EMS of a wireless communication network, the expansible EMS comprising:
an EMS application server comprising a system back-end function unit for performing at least one of a configuration management function, a fault management function, a download management function, and a status management function, in response to a command transmitted from an EMS client, and a system resource management unit for transmitting the command to an EMS element interface server; and
at least one EMS element interface server comprising an interface for matching with the elements based on TCP communication or SNMP communication, and a system resource agent for managing the interface by interworking with the system resource management unit.

21. The expansible EMS as claimed in claim 20, wherein the EMS application server further comprises a system front-end function unit for matching with the EMS client.

22. The expansible EMS as claimed in claim 20, wherein the EMS element interface server further comprises at least one of:
a command receiver for receiving a command transmitted from the EMS application server and transmitting the command to elements of the wireless communication network;
a network element active checker for checking if the elements of the wireless communication network are alive;
a database synchronizer for performing a function of synchronizing with a database server interworking with the EMS element interface server;
a log handler for processing a log file regarding the elements of the wireless communication network with which the EMS element interface server matches; and
a statistics information collector for collecting statistics related data for the elements of the wireless communication network with which the EMS element interface server communicates and transmitting the collected data to the EMS application server.

23. The expansible EMS as claimed in claim 20, wherein the EMS application server further comprises an NMS interface unit for matching with the NMS of the wireless communication network, and the NMS interface unit is constructed to be separable from the EMS application server.
